(19) United States
(12) Patent Application Publication
(10) Pub. No.: US 2020/0376615 A1
(43) Pub. Date: Dec. 3, 2020

(54) PRODUCTION METHOD FOR PRODUCING A HEAT EXCHANGER ASSEMBLY AND HEAT EXCHANGER ASSEMBLY FOR COOLING AND/OR HEATING A HEAT EXCHANGER FLUID

(71) Applicant: Mahle International GmbH, Stuttgart (DE)

(72) Inventors: Andreas Koenig, Muehlacker (DE); Dieter Reisinger, Vaihingen/Enz (DE); Erwin Skiba, Stuttgart (DE); Daniel Stehlik, Freiberg A. Neckar (DE); Christoph Walter, Stuttgart (DE); Manuael Wehowski, Bietigheim-Bissingen (DE)

(21) Appl. No.: 16/885,248

(22) Filed: May 27, 2020

(30) Foreign Application Priority Data
May 28, 2019 (DE) 102019207830.3

(51) Int. Cl. B23P 15/26; F28D 9/00

(52) U.S. Cl. CPC B23P 15/26; F28D 9/0093

(57) ABSTRACT

A production method for producing a heat exchanger assembly, which may serve for at least one of cooling and heating a functional component via a heat exchanger fluid, may include first providing a duct flat body, which may have a flow duct comprising a clear flow cross section, through which heat exchanger fluid may be flowable. The method then may include forming the duct flat body as part of a rolling process or as part of a roller burnishing process to form a bent cylinder jacket-shaped heat exchanger housing. The method then may include arranging the bent heat exchanger housing on a jacket surface of the functional component, and fixing the heat exchanger housing on the jacket surface of the functional component.

### CROSS-REFERENCE TO RELATED APPLICATIONS

This application claims priority to German Patent Application No. DE 10 2019 207 830.3, filed on May 28, 2019, the contents of which is hereby incorporated by reference in its entirety.

### TECHNICAL FIELD

The invention relates to a production method for producing a heat exchanger assembly as well as a heat exchanger assembly for cooling and/or heating a functional component by means of a heat exchanger fluid.

### BACKGROUND

Production methods for producing heat exchanger assemblies, in particular heat exchanger assemblies for electric drive devices, have been known for a long time and are preferably used in the field of motor vehicle technology, in order to produce heat exchanger assemblies, which can be used there for electric drive device.

Today, relatively high drive torques and relatively high drive capacities are desirable in particular in the field of electric drive devices. The relatively high performance requirements, however, are associated with a heating of the drive components of the electric drive device, in particular when an electric drive device is operated for a longer period of time. The heating of the electric drive device thereby has a variety of causes and can be traced back, for example, to the electrical ohmic resistance of coil assemblies, to remagnetization effects within the electric drive devices, to eddy current losses or bearing friction. A heating routinely results in that the drive components of the electric drive devices, for example drive bearings or the insulation of coil assemblies, have to withstand relatively strong thermal stresses. Heat exchanger assemblies are thus routinely used to reduce the thermal stresses.

Various methods are conceivable to produce heat exchanger assemblies, for example the German publication DE 3738592 C1 describes that heat exchanger assemblies can be produced as part of a diecasting method. A heat exchanger assembly thereby comprises at least one heat exchanger, which, in turn, has two heat exchanger housing parts. The heat exchanger housing parts are each produced in a separate diecasting method and, in the assembled state, form a multi-part heat exchanger, through which heat exchanger fluid can flow.

A heat exchanger assembly is also described in publication EP 2975734 A2. Several stator laminations of a stator of an electric drive device are equipped here with several radial recesses, which extend longitudinally through the stator, wherein the radial recesses can subsequently be flushed with a heat exchanger fluid to cool the electric drive device.

The known production methods for producing heat exchanger assemblies are ideally suited for cooling and/or heating a functional component by means of a heat exchanger fluid, in particular for cooling and/or heating an electric drive device. From a procedural aspect, however, there is the challenge of either having to provide several relatively complex near-net-shape diecasting molds (casting molds) or of having to perform a relatively time-consuming and costly finishing of a stator of an electric drive device, even though more cost-efficient production methods for heat exchanger assemblies would be advantageous from the aspect of competition.

### SUMMARY

The object of the invention thus lies in proposing an improved or at least another production method for a heat exchanger assembly and an improved or at least another heat exchanger assembly.

In the case of the present invention, this object is solved in particular by means of the subject matters of the independent claims. Advantageous embodiments are subject matter of the dependent claims and of the description.

The basic idea of the invention is to provide a production method for heat exchanger assemblies, in the case of which one or several duct flat bodies forming a heat exchanger housing of a heat exchanger of the heat exchanger assemblies are formed from a planar, in particular non-curved, provision state. While the known production methods for heat exchanger assemblies aim at producing the heat exchanger housings directly, quasi by means of primary forming, so as to be near-net-shape, the present proposal opens up the possibility of operating from a level, in particular a two-dimensional, provision state. Less complex tools are thus required for the production method as compared to, for example, a diecasting method.

Several steps, which are to in particular be performed one after the other, are provided as part of the proposed production method for a heat exchanger assembly for cooling and/or heating a functional component by means of a heat exchanger fluid. First of all, one or several duct flat bodies are provided as part of a first step. Each or at least a single duct flat body thereby has one or several flow ducts, through which heat exchanger fluid can flow and which are each equipped with a clear flow cross section. The duct flat body is, for example, a rectangular duct body, which is hollow on the inside, or a rectangular tube or another tube body. As an example, each duct flat body is made of a material, which is suitable for welding and/or soldering, for example of a metal material or a plastic material. The duct flat body can further be constructed of two flat, in particular non-curved or planar or level plate bodies, which are fixed to one another by means of a substance-to-substance bond beforehand. For example a laser welding process or a soldering method is suitable for this purpose. It is an advantage thereby that the duct body can be produced in the level state, quasi in the two-dimensional state, so that a near-net-shape primary forming method, for example the mentioned diecasting method, can be forgone.

According to a further step, it is provided to form or to bend over the provided duct flat body or duct flat bodies, namely as part of a rolling process, in particular by means of roller bending or as part of a roller burnishing process. The duct flat body is thereby plastically formed permanently little by little in any case in a single rolling step or roller burnishing step or by means of one or several repetitions of the rolling step or of the roller burnishing step. The duct flat body thereby transitions from a level state, quasi from a two-dimensional state, into a bent shape. The free or clear cross section, respectively, of the duct flat body remains continuous, in particular open or free, as part of the rolling process or of the roller burnishing process, so that heat exchanger fluid can later flow through the duct flat body. The duct flat bodies are thereby in particular relatively thin-walled and relatively soft, so that joints, for example laser joints and/or solder joints, are not damaged by the rolling or roller burnishing process. After this step, the duct flat body advantageously forms a bent, in particular cylinder jacket-shaped, and three-dimensional heat exchanger housing, which can be arranged for example relatively easily on an electric drive device.

As part of a further step, the duct flat body, which has now been formed and which is referred to as heat exchanger housing, is arranged on a functional component, in particular on a jacket surface or a stator surface, of an electric drive device or of a stator jacket surface of an electric drive device. The heat exchanger housing is thereby fixed, in particular releasably or non-releasably, to the functional component, for example clamped by interconnecting a contact means, such as casting compound.

As a result, this production method provides a heat exchanger housing, which is transferred from the two-dimensional level provision state into a three-dimensional heat exchanger housing only by means of a rolling or roller burnishing process. This has the advantage that relatively complex tools for the near-net shape primary forming, as they are known from the prior art, can be forgone, so that the production method for a heat exchanger assembly is relative cost efficient as compared to the production method known from the prior art. In addition, the production method described here has the advantage that, compared to conventionally produced heat exchanger assemblies, a heat exchanger assembly is improved with respect to its weight as well as with respect to its installation space.

An additional step, which is referred to as expansion step, which is performed prior to the first step or instead of the first step, is advantageously provided as part of the production method. First of all, two or several level plate flat bodies, which form the duct flat body, are placed one on top of the other with contact, in particular congruently, as part of the expansion step. The plate flat bodies are thereby preferably virtually unbent and completely level. The level plate flat bodies, which are located one on top of the other with contact, are then connected to one another by means of a substance-to-substance bond as part of a joining method, in particular by means of soldering or welding. Due to the fact that the plate flat bodies are connected in the unbent, in particular flat and level state, relatively complex and cost-intensive forming production methods, such as, for example, diecasting methods, can be forgone, and simpler soldering and welding methods can instead be resorted to. The production method is thus relatively cost-efficient and is also relatively quick as compared to the known production methods, so that high cycle times, for example, can be realized.

A further additional step, which is referred to as further expansion step, can in particular be provided, The further expansion step is performed prior to the first step or instead of the first step or prior to the expansion step or instead of the expansion step. It is provided as part of the further expansion step in any case to arrange one or several bead bodies or burl bodies forming a functional structuring on one or all plate flat bodies. The bead bodies or the burl bodies can be formed into the plate flat bodies, for example by means of a rolling process. It can further be provided as part of the further expansion step to arrange one or several pin bodies forming a functional structuring on one or all plate flat bodies. The pin bodies are, for example, cylindrical flow bodies, which are attached to the respective plate flat bodies, for example by means of adhesion, soldering or welding. The production or keeping the free or clear flow cross section of the duct flat body open, respectively, can be promoted by arranging a functional structuring on at least one plate flat body.

To attain that the plate flat bodies, which are arranged one on top of the other and which are connected to one another, thus the duct flat body, are formed into a round, in particular completely round or half-round shape, as part of the rolling process or of the roller burnishing process, it is preferred when the rolling process is realized by means of a roll bending method. The plate flat bodies and/or the duct flat bodies can thus transition into a round, in particular completely round, or half-round shape, by maintaining the free or clear flow cross section, respectively.

The duct flat body can further be clamped between a single or several rolling roller pairs and can be moved bidirectionally or back and forth, respectively, to permanently plastically deform, thus to bend, the duct flat body by maintaining the clear flow cross section in a single bending step or little by little, i.e. in several individual bending steps as part of the preferred roll bending method. In response to this process, a cylinder jacket-shaped shape of the duct flat body can advantageously be attained, so that the duct flat body can then also be referred to as heat exchanger housing.

It is possible that a single or each of the mentioned rolling roller pairs each comprises two or more rolling rollers for bending the duct flat body, wherein each rolling roller in each case has a rolling roller diameter. It is preferred, however, when the rolling roller diameter of a first rolling roller is set to be larger than the rolling roller diameter of a second rolling roller. The advantage is thus attained that the one rolling roller rotates quicker than the other rolling roller. A duct flat body clamped between the rolling rollers can thus be bent, so that the bending function is realized.

A further basic idea of the invention is to specify a further production method for producing a heat exchanger assembly. According to a first step, it is provided to provide at least two or more base plates. A first base plate is thereby designed to be planar, in particular flat and unbent. The first base plate has a first base plate large surface and a second base plate large surface, which is oriented opposite thereto. A second base plate is further provided, which is optionally designed to be identical to the first base plate, thus planar, in particular flat and unbent. The second base plate advantageously has a third base plate large surface and a fourth base plate large surface oriented opposite thereto. The two base plates are advantageously identical in terms of area, so that they can be placed one on top of the other congruently. The two base plates can be formed by means of a plate flat body. At least one or all base plates, in particular the second base plate, comprise a functional structuring, which comprise pin bodies and/or bead bodies, which are arranged on the respective base plate or on one of the base plate large surfaces and which in particular protrude orthogonally away from the latter. One or several base plates, in particular the second base plate, can each have a joint frame web, which advantageously surrounds the functional structuring in a frame-like manner. Each joint frame web advantageously defines a joint mounting surface, on which, for example, a further joint mounting surface of a further base plate can be arranged.

According to a second step of the further production method, it is provided to place one, two or all base plates one on top of the other congruently, in particular in such a way that the joint frame webs thereof, in particular the joint mounting surfaces thereof, rest against one another with contact. It is preferred, however, when the first or second base plate large surface of the first base plate is arranged on the pin bodies and/or bead bodies of the functional structuring and/or of the joint mounting surface of the joint frame web of the second base plate with contact and advantageously by forming an intermediate gap between the first and second base plate. The intermediate gap thereby defines one or several clear flow cross sections of one or several flow ducts, through which heat exchanger fluid can flow in each case.

According to a third step of the further production method, the connection by means of a substance-to-substance bond of the base plates, which are located one on top of the other, is provided, for example as part of a soldering method or of a welding method. A base plate intermediate component is thus formed. As part of the soldering method or of the welding method, the base plates are advantageously connected to one another by means of a substance-to-substance bond, advantageously along the joint mounting surface(s) and/or at contact points between the base plates and the functional structuring. The base plate intermediate component is thereby preferably relatively thin-walled and relatively soft.

According to an optional fourth step of the further production method, the arrangement of a fluid supply port assembly, which communicates with the flow duct, is provided on the base plate intermediate component. The fluid supply port assembly can be fastened, for example, to the base plate intermediate component as part of a soldering method or of a welding method. After the arrangement of the fluid supply port assembly on the base plate intermediate component, the base plate intermediate component is also referred to as duct flat body.

According to a fifth and sixth step of the further production method, the permanent plastic formation of the base plate intermediate component or of the duct flat body is provided as part of a rolling method or as part of a roller burnishing method, in particular by means of roller bending. The base plate intermediate component or the duct flat body is thereby clamped in any case between a rolling roller pair and is moved bidirectionally, whereby the base plate intermediate component or the duct flat body transitions into a bent shape, in particular a round or completely round shape. The base plate intermediate component or the duct flat body advantageously transitions into the bent state due to pressure solidification. The rolling roller pair in particular has two rolling rollers, which each have a differently large rolling roller diameter and which promote the forming of the base plate intermediate component or of the duct flat body. During the rolling, the fluid supply port assembly can be arranged outside of a roller engagement area, so that the fluid supply port assembly is not damaged.

According to a seventh step of the further production method, steps five and/or six of the further production method can be repeated, so that the base plate intermediate component or the duct flat body is formed further and stronger. For example, the base plate intermediate component or the duct flat body can be moved bidirectionally relatively often, until it is bent in an essentially cylinder jacket-shaped manner, and/or has a circular ring-shaped cross section, based on a main expansion direction of the base plate intermediate component or of the duct flat body. The base plate intermediate component or the duct flat body then forms an, in particular cylinder jacket-shaped, heat exchanger housing in any case.

As part of step one of the further production method, it can preferably be provided that a functional structuring is arranged not only on the second base plate, but additionally also on the first base plate or on one or on both base plate large surfaces of the first base plate. The functional structuring comprises, for example, a plurality of pin bodies or bead bodies or burl bodies.

To ensure a heat transfer from the functional component to a heat exchanger fluid, which flows through the heat exchanger housing, the application of the cylinder jacket-shaped heat exchanger housing against the functional component, and fixation of the cylinder jacket-shaped heat exchanger housing to a cylinder jacket surface of the functional component can be provided according to a step eight, which is added after step seven.

To fix the bent base plate intermediate component or the duct flat body, one or several clamping devices are provided in particular on a jacket surface of the functional component, in particular on a jacket surface of a stator of an electric motor, advantageously according to step seven of the further production method for producing a heat exchanger assembly. A single clamping device is thereby advantageously realized by means of one or several clamping straps or one or several screw connections or by means of one or several hose clamps or a spring assembly. When fixing the heat exchanger housing, in particular heat-conducting contact compound or casting compound can be arranged between the heat exchanger housing and the functional component

The bent base plate intermediate component, in particular the duct flat body, advantageously has two free ends, which are located opposite one another in a circumferential direction around the bent base plate intermediate component, thus in particular around the duct flat body. One or alternatively several clamping devices are thereby in each case advantageously arranged on the two free ends or in the area of the free ends. A clamping device is formed, for example by means of a spring assembly, which comprises at least one spring element and a corresponding spring element receptacle. To apply and fix the bent base plate intermediate component, in particular the duct flat body, against the functional component according to step seven of the further production method, the spring elements and the spring element receptacles are releasably clamped to one another. This has the advantage that the base plate intermediate component, in particular the duct flat body, which forms the heat exchanger, can be arranged relatively quickly and without further receiving means on the functional component, in particular on a stator of an electric motor.

To be able to provide heat exchanger fluid for cooling and/or heating an electric drive device at the heat exchanger assembly, in particular at the heat exchanger or at the duct flat body, it is provided that the fluid supply port assembly has at least a single or several, in particular two, three or four, fluid supply ports. The fluid supply ports have, for example, a tubular or hose-like shape, thus embodied either as rigid tube bodies or as elastic hose bodies. The fluid supply ports can be connected in any case to a fluid supply device, which provides heat exchanger fluid, so that the heat exchanger assembly can be supplied with heat exchanger fluid.

The invention comprises the further basic idea of providing a heat exchanger assembly for cooling and/or heating by means of a heat exchanger fluid. Advantageously, the heat exchanger assembly is suitable for cooling and/or heating an electric drive device, in particular an electric motor. The heat exchanger assembly is advantageously made as part of the above-described production method for producing heat exchanger assemblies. The heat exchanger assembly comprises in particular a heat exchanger having a circular cylindrical heat exchanger housing. The heat exchanger is preferably suited for being arranged on a functional component, in particular on an electric drive or an electric motor or a stator of an electric motor. The heat exchanger housing has at least one flow duct comprising a free flow cross section, through which heat exchanger fluid can flow, wherein a functional structuring comprising a plurality of pin bodies or bead bodies or burl bodies is arranged on one or both base plates, which form the heat exchanger housing. The pin bodies of the functional structuring thereby protrude into the free flow cross section and/or rest against the respective opposite base plate.

The functional structuring of the heat exchanger assembly advantageously forms a surface structuring, in particular a pin body structuring, a bead body structuring or a burl body structuring. The pin bodies, the bead bodies or the burl bodies of the functional structuring are thereby in each case formed by, in particular pin-, burl- or bead-like hemispherical bodies.

An electrically operable motor vehicle, in particular an electric vehicle, can in particular be equipped with a heat exchanger assembly. The heat exchanger assembly has one or several of the above-described heat exchanger assembly features and is coupled or can be coupled to at least one electric drive device of the motor vehicle, which is suitable for driving the motor vehicle. As an example, the electric drive device comprises one or several electric motors, which are each equipped with a stator assembly and an armature assembly. The heat exchanger assembly is coupled or can be coupled in particular to one of the electric motors, so as to ensure a cooling and/or heating of the respective electric motor.

In summary, it should be noted: The present invention relates to a production method for producing a heat exchanger assembly, advantageously for cooling and/or heating a functional component by means of a heat exchanger fluid, in particular for cooling or heating an electric drive, comprising the steps of: providing a duct flat body, which has a flow duct comprising a clear flow cross section, through which heat exchanger fluid can flow; forming the duct flat body as part of a rolling process or as part of a roller burnishing process to form a bent cylinder jacket-shaped heat exchanger housing; arranging the bent heat exchanger housing on a jacket surface of a functional component, and fixing the heat exchanger housing on the jacket surface of the functional component. The term “heat exchanger” will be used synonymously to the term “heat exchanger”.

Further important features and advantages of the invention follow from the subclaims, from the drawings, and from the corresponding figure description on the basis of the drawings.

It goes without saying that the above-mentioned features and the features, which will be described below, cannot only be used in the respective specified combination, but also in other combinations or alone, without leaving the scope of the present invention.

Preferred exemplary embodiments of the invention are illustrated in the drawings and will be described in more detail in the following description, whereby identical reference numerals refer to identical or similar or functionally identical components.

### BRIEF DESCRIPTION OF THE DRAWINGS

In each case schematically,

FIG. 1 shows a flow chart of the production method for producing a heat exchanger assembly comprising three steps;

FIG. 2 shows the provision of a duct flat body in a perspective view;

FIG. 3 shows a duct flat body in a top and side view;

FIG. 4 shows a further duct flat body in a top and side view;

FIG. 5 shows a further duct flat body in a top and side view;

FIG. 6 shows a side view of the rolling or roller burnishing process according to the production method;

FIGS. 7 and 8 each show a heat exchanger housing produced according to the production method, in each case in a top view;

FIG. 9 shows a perspective view of a heat exchanger assembly for cooling and/or heating by means of heat exchanger fluid.

### DETAILED DESCRIPTION

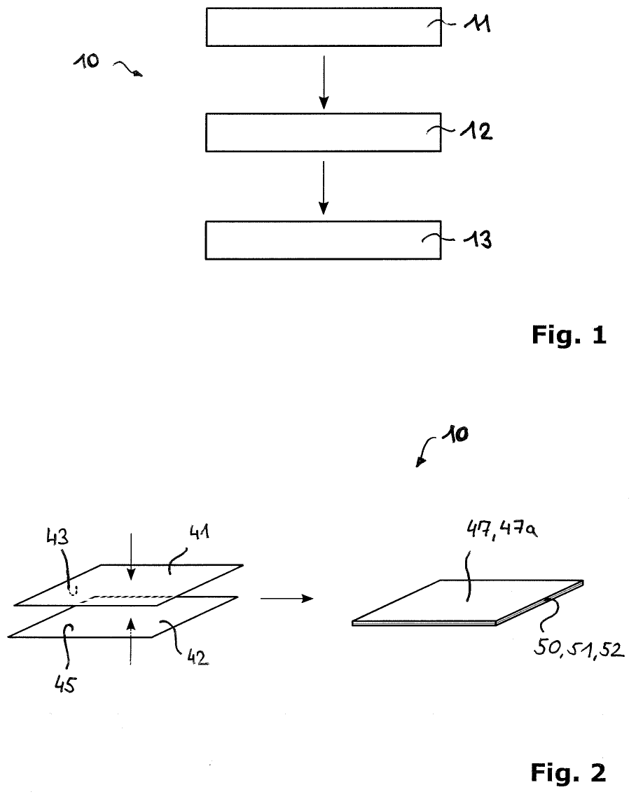

As a whole, FIGS. 1 to 9 show a production method 10 for producing a heat exchanger assembly 20. Heat exchanger assemblies 20 of this type are used in particular in motor vehicles in the case of electric drive devices, in order to contribute to the reduction of the thermal stresses to the respective electric drive device.

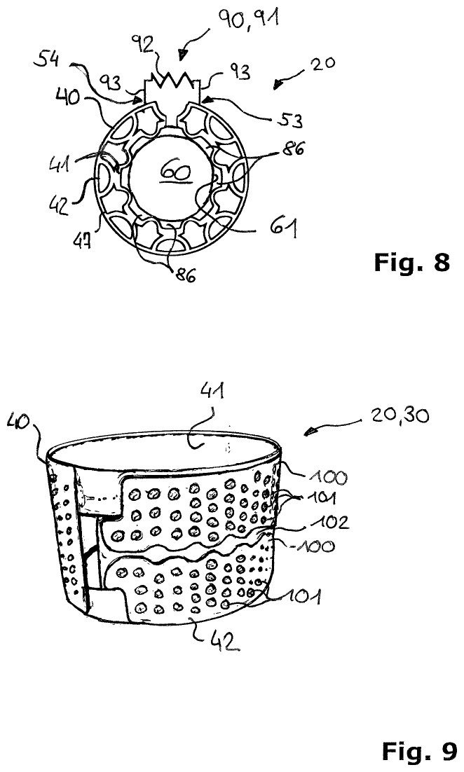

A flow chart of the production method 10 for producing a heat exchanger assembly 20 can be seen in FIG. 1. It comprises three steps, which are each suggested in an exemplary manner by a rectangular box 11, 12, 13. A first step suggested by the box 11 comprises the provision of a duct plate body 47, through which heat exchanger fluid can flow. Subsequently, the duct flat body 47 is permanently plastically formed as part of a second step, wherein the second step is symbolized by a rectangular box 12 in FIG. 1. The forming can take place, for example, as part of a rolling process or as part of a roller burnishing process. A rectangular box 13, by means of which a third step of the production method 10 is symbolized, can further be seen in FIG. 1. As part of the third step, the formed duct flat body 47, which is now also referred to as heat exchanger housing 40, is arranged and fixed on a jacket surface 61 of a functional component 60, which is suggested in FIGS. 7 and 8.

It can be seen in FIG. 2, how two base plates 41, 42, which form the duct flat body 47 or the base plate intermediate component 47a, respectively, are placed one on top of the other, so that they rest against one another with contact with their base plate large surfaces 43, 45. As an example, the two base plates 41, 42 are designed identically, in particular in terms of area and in terms of contour, so that they can rest one on top of the other congruently with contact. For example, the two base plates 41, 42 are each level plate flat bodies, which are not described in more detail. It cannot be seen in FIG. 2 that the two base plates 41, 42 are placed one on top of the other in such a way that an intermediate gap 52 is defined between them. The intermediate gap 52 forms an open or clear flow cross section 51, respectively, of a flow duct 50, through which heat exchanger fluid can flow.

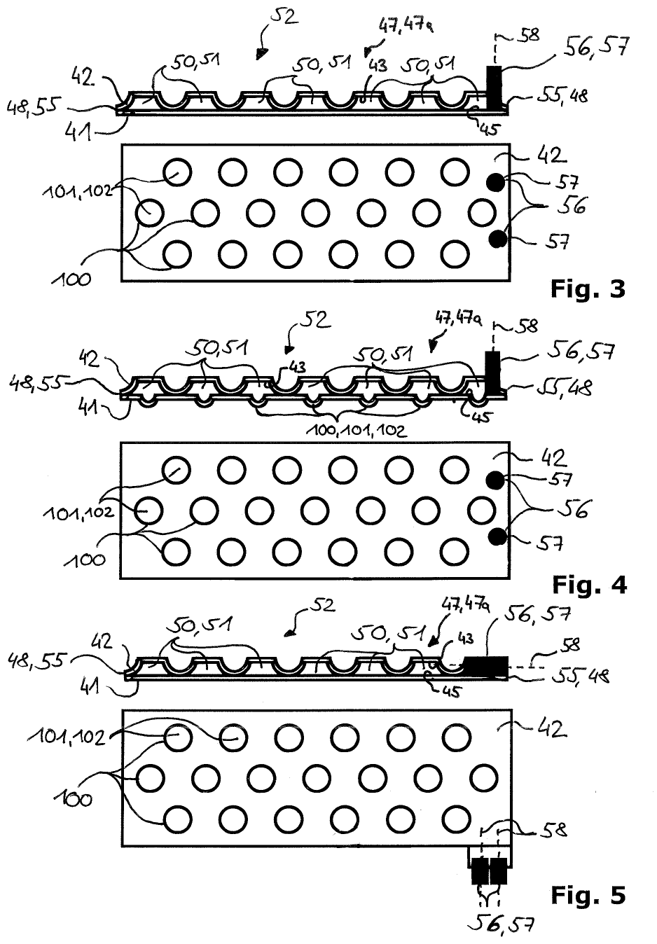

Two base plates 41, 42, which are placed one on top of the other with contact and which form a duct flat body 47 or the base plate intermediate component 47a, respectively, are in each case also illustrated in a top and side view in FIGS. 3 to 5. In contrast to FIG. 2, however, an intermediate gap 52 and several free flow cross sections 51, in particular several flow ducts 50, can be seen in each case. It can further be seen that the second base plate 42 has a functional structuring 100.

The functional structuring 100 thereby comprises at least one and advantageously several pin bodies 101 and/or bead bodies 102, which are each arranged on the second base plate 42 and protrude into the intermediate gap 52 or the free flow cross sections 51, respectively, of the flow duct 50. A joint frame web 55, which surrounds the functional structuring 100 in a frame-like manner, is further arranged on the second base plate 42. The joint frame web 55 has, for example, a joint mounting surface 48, with which the second base plate 42 can rest against the first base plate 41 with contact. In this case, the first base plate 41 is designed to be level or planar, in particular unbent. For example, the pin bodies 101 and/or the bead bodies 102 of the functional structuring 100 rest against the first base plate 41 with contact. It can further be seen according to FIG. 3 to FIG. 5 that a fluid supply port assembly 56 is connected to the two base plates 41, 42, the fluid supply port assembly 56 is soldered or welded or adhered, for example, to one or to both base plates 41, 42. The fluid supply port assembly 56 is preferably connected to one or all flow ducts 50 so as to communicate therewith in any case, so that heat exchanger fluid can be provided to one or all flow ducts 51 by means of a non-illustrated fluid supply device via the fluid supply port assembly 56. As an example, the fluid supply port assembly 56 has two fluid supply ports 57, which are oriented parallel to one another. The fluid supply ports 57 or the fluid supply port assembly 56 in each case advantageously define an axial port longitudinal axis 58 along their respective main expansion direction.

It should be added that, according to FIGS. 3 and 4, the port longitudinal axis 58 is preferably arranged orthogonally to the base plate large surfaces 43, 45 of the two base plates 41, 42, so that a right angle is quasi spanned between the port longitudinal axis 58 and a plate plane of the base plates 41, 42. The fluid supply port assembly 56 and/or the fluid supply ports 57 are thereby advantageously arranged on a longitudinal front side of the two base plates 41, 42, in particular on a long or a short longitudinal front side of the base plate 41, 42.

The base plates 41, 42, which are arranged one on top of the other, can be seen in FIG. 4, which, in contrast to FIGS. 3 and 5, each have a separate functional structuring 100, so that, as a result, several pin bodies 101 and/or several bead bodies 102 are arranged on both base plates 41, 42.

In contrast to FIGS. 3 and 4, FIG. 5 shows that a port longitudinal axis 58 of the fluid supply port assembly 56 and/or a port longitudinal axis 58 of the fluid supply ports 57 lies completely in a plate plane of the base plates 41, 42 or is arranged parallel to a plate plane. The fluid supply port assembly 56 and/or the fluid supply ports 57 are thereby advantageously arranged on a longitudinal front side of the two base plates 41, 42, in particular on a long or a short longitudinal front side of the base plates 41, 42.

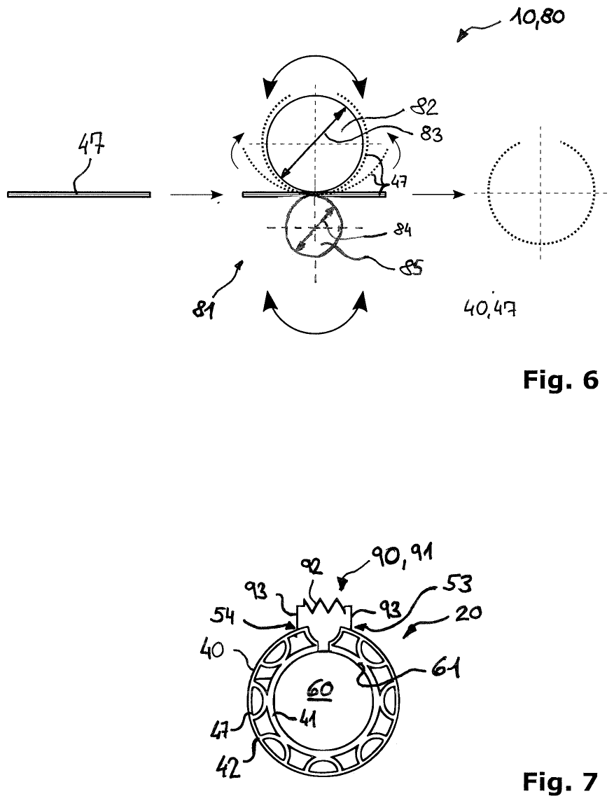

FIG. 6 shows a rolling process or a roller burnishing process, respectively, which is performed as part of the production method, in a side view. The rolling process is advantageously a roll bending method 80, as part of which the use of a rolling roller pair 81 is provided.

The rolling roller pair 81 advantageously comprises at least two or more individual rolling rollers 82, 85, which can differ from one another for example in the rolling roller diameter 83, 84. According to FIG. 6, the rolling roller diameters 83, 84 are embodied with a different diameter. A duct flat body 47 can be clamped and processed between the rolling roller pair 81 in any case. Relatively high forming forces act on the duct flat body 47 when clamped in the rolling roller pair 81. If the duct flat body 47 is moved bidirectionally between the rolling roller pair 81 for a relatively long time, the duct flat body 47 transitions into a bent shape little by little. The transition of the duct flat body 47 from the level state into a round or bent state is illustrated in FIG. 6 by means of arrows and by dots between bending states of the duct flat body 47. After performing the rolling bending, the duct flat body 47 has a round, in particular a circular, completely circular or ring-like, appearance and forms a heat exchanger housing 40, which is suggested in FIG. 6 with dots in an exemplary manner.

FIGS. 7 and 8 each show a heat exchanger housing 40 produced according to the production method, in a top view. It can be seen thereby that the first and second base plate 41, 42 or the duct flat body 47, respectively, has transitioned into a shape, the cross section of which is round, in particular a completely round or circular ring-shaped shape. To arrange the heat exchanger housing 40 on a cylinder jacket surface 61 of a functional component 60, for example a stator jacket surface of an electric drive device or the jacket surface of an electric motor, a clamping device 90 is provided, which, as an example, is a spring assembly 91. It can be provided that the spring assembly 91 has a spring element 92 and one or several spring element receptacles 93, which are arranged around the duct flat body 47 on opposite free ends 53, 54 of the duct flat body 47 in a circumferential direction. The heat exchanger housing 40 can be arranged and fixed on the cylinder jacket surface 61 of the functional components 60 with the help of the spring assembly 91.

In contrast to FIG. 7, FIG. 8 shows that a functional structuring 100 can also be arranged on the first base plate 41. The pin bodies 101 and/or bead bodies 102 of the functional structuring 100 are thereby arranged on the cylinder jacket surface 61 of the functional component 60, for example by forming additional longitudinal structures 86, which, as an example, serve the purpose of cooling and/or heating a structured surface.

Lastly, a perspective view of an exemplary heat exchanger 30 of a heat exchanger assembly 20 comprising a heat exchanger housing 40 for cooling and/or heating a functional component by means of a heat exchanger fluid is illustrated in FIG. 9. The two base plates 41, 42, which form the heat exchanger housing 40 of the heat exchanger 30, as well as two functional structurings 100 arranged thereon, each comprising a plurality of pin bodies 101 or bead bodies 102, can be seen.

1. A production method for producing a heat exchanger assembly, which serves for at least one of cooling and heating a functional component via a heat exchanger fluid, comprising:
providing a duct flat body, which has a flow duct comprising a clear flow cross section, through which heat exchanger fluid is flowable;
forming the duct flat body as part of a rolling process or as part of a roller burnishing process to form a bent cylinder jacket-shaped heat exchanger housing;
arranging the bent heat exchanger housing on a jacket surface of the functional component and fixing the heat exchanger housing on the jacket surface of the functional component.

2. The production method according to claim 1, comprising:
connecting at least two plate flat bodies via a substance-to-substance bond to form the duct flat body.

3. The production method according to claim 2, comprising:
arranging bead bodies or pin bodies of a functional structuring on at least one of the plate flat bodies prior to connecting the at least two plate flat bodies.

4. The production method according to claim 1, wherein the rolling process is a roll bending method.

5. The production method according to claim 4, wherein the roll bending method includes:
clamping the duct flat body between a rolling roller pair; and
moving the duct flat body bidirectionally so as to bend the duct flat body into a circular or ring-like cylinder jacket-shaped heat exchanger housing by maintaining a clear flow cross section.

6. The production method according to claim 5, wherein the rolling roller pair comprises two or more rolling rollers for bending the duct flat body, wherein each rolling roller has a rolling roller diameter, and wherein the rolling roller diameter of a first of the rolling rollers is larger than the rolling roller diameter of a second of the rolling rollers.

7. A production method for producing a heat exchanger assembly, which serves for at least one of cooling and heating a functional component via a heat exchanger fluid, comprising:
providing at least a first base plates and a second base plate, wherein:
the first base plate, which is designed to be planar, comprises a first base plate large surface and a second base plate large surface, which is oriented opposite thereto; and
the second base plate comprises a third base plate large surface and a fourth base plate large surface oriented opposite thereto, wherein the second base plate has a functional structuring, which comprises pin bodies, which are arranged on the second base plate or on one of the third base plate large surface or the fourth base plate large surfaces, and the second base plate has a joint frame web, which surrounds the functional structuring in a frame-like manner;
placing the first and second base plates one on top of one another, so that the first or second base plate large surface of the first base plate rests against at least one of (i) the pin bodies of the functional structuring and (ii) a joint mounting surface of the joint frame web with contact and by forming an intermediate gap;
connecting the first and second base plates, which are located one on top of one another, via a substance-to-substance bond as part of a soldering method to form a base plate intermediate component, wherein the first and second base plates are connected to one another along the joint mounting surface by forming a flow duct, wherein the intermediate gap defines a clear flow cross section;
arranging a fluid supply port assembly, which communicates fluidically with the flow duct, on the base plate intermediate component as part of a soldering method so as to provide a duct flat body;
forming the duct flat body as part of a rolling method, wherein the duct flat body is clamped between a rolling roller pair;
bidirectionally moving the duct flat body between rolling rollers of the rolling roller pair, so that the duct flat body is bent; and
repeating the bidirectional moving of the duct flat body until the duct flat body at least one of (i) is bent to be essentially cylinder jacket-shaped and (ii) has a circular ring-shaped cross section, based on a main expansion direction of the duct flat body, so that a cylinder jacket-shaped heat exchanger housing is formed.

8. The production method according to claim 7, further comprising applying the cylinder jacket-shaped heat exchanger housing against the functional component, and fixing the cylinder jacket-shaped heat exchanger housing to a cylinder jacket surface of the functional component, so as to ensure a heat energy transfer from the functional component to a heat exchanger fluid, which flows through the heat exchanger housing.

9. The production method according to claim 7, wherein pin bodies of the functional structuring are additionally arranged on the first base plate or on one or on both of the first and second base plate large surfaces of the first base plate.

10. The production method) according to claim 7, wherein:
at least one clamping devices is arranged on the base plate intermediate component or on the bent duct flat body for fixing the bent duct flat body to a jacket surface of the functional component.

11. The production method according to claim 10, wherein:
each clamping device comprises at least one clamping strap, at least one screw connection, at least one hose clamp, or a spring assembly.

12. The production method according to claim 7, wherein:
the bent duct flat body has two free ends, which are located opposite one another in a circumferential direction around the bent duct flat body, wherein several clamping devices are in each case arranged on the two free ends or in an area of the free ends and wherein the clamping devices are releasably clamped to one another for applying and fixing the duct flat body against the functional component.

13. A heat exchanger assembly for at least one of cooling and heating a functional component by means of a heat exchanger fluid, comprising a heat exchanger having a circular cylindrical heat exchanger housing for arrangement on a functional component, wherein the heat exchanger housing has at least one flow duct comprising a free flow cross section, through which heat exchanger fluid is flowable, wherein a functional structuring comprising a plurality of pin bodies is arranged on at least one of a first base plate and a second base plates, which form the heat exchanger housing, wherein the pin bodies at least one of protrude into the free flow cross section and rest against the respective opposite base plate with contact.

14. The heat exchanger assembly according to claim 13, wherein the functional structuring is a burl structuring, and wherein the pin bodies are each formed by burl-like hemispherical bodies or by bead bodies.

15. The production method according to claim 2, wherein the substance-to-substance bond is soldering or welding.

16. The production method according to claim 4, wherein the roll bending method is roller bending.

17. The production method according to claim 7, wherein each rolling roller has a rolling roller diameter, and wherein the rolling roller diameter of a first of the rolling rollers is larger than the rolling roller diameter of a second of the rolling rollers.

18. The production method according to claim 7, wherein the roll bending method is roller bending.

19. (canceled)

20. The production method according to claim 12, wherein the clamping devices include a spring assembly having a spring element and a spring element receptacle, wherein the spring element and the spring element receptacle are releasably clamped to one another for applying and fixing the duct flat body against the functional component.

21. The production method according to claim 1, the clear flow cross section of the duct flat body remaining continuously open during at least one of the rolling process and the roller burnishing process.
